(19) United States
(12) Patent Application Publication
(10) Pub. No.: US 2006/0133192 A1
(43) Pub. Date: Jun. 22, 2006

(54) Device for spraying liquid mixtures

(76) Inventor: Wolf-Dieter Wichmann, Huelben (DE)

Correspondence Address: FLYNN THIEL BOUTELL & TANIS, P.C., 2026 RAMBLING ROAD, KALAMAZOO, MI, 49008-1631, US

(21) Appl. No.: 11/303,253

(22) Filed: Dec. 16, 2005

Related U.S. Application Data
(60) Provisional application No. 60/638,538, filed on Dec. 22, 2004.

(30) Foreign Application Priority Data
Dec. 17, 2004 (DE) 102004062439.9

(51) Int. Cl. B01F 15/02

(52) U.S. Cl. 366/132

(57) ABSTRACT

A device for spraying liquid mixtures, in particular for discharging crop protection agents in agriculture, is described. The device is provided with at least one spray nozzle and a mixing device attached in front thereof having a metering arrangement for the liquids to be mixed and a cylindrical mixing chamber with tangential liquid supply. The metering device, which can in particular be provided for discontinuous and pulse-effected admixing of the crop protection agent, is arranged in front of the mixing chamber. The liquid supply to the mixing chamber (5, 16) is provided with one or more outlet apertures extending over the entire axial length (I) of the mixing chamber (5, 16) and of which the free cross-section is determined by a control element (9, 17) opening or closing depending on the liquid pressure. This control element can be a spring-loaded control flap (9) of which the free end is located in front of an outflow slot (8) that also extends over the entire length (I) of the mixing chamber. In a variant, this control element can also be a curved leaf spring (17) located in the mixing chamber (16), the free end (17a) of which spring extends over the outlet apertures. This embodiment ensures automatic adjustment of the inlet cross-section into the mixing chamber for the respective flow speed required to keep the liquid in contact with the wall of the mixing chamber and to achieve in this way a good and homogeneous mixing of the crop protection agent with the water used as the carrier liquid.

### CROSS REFERENCE TO PRIOR APPLICATION

This application claims priority to German Patent Application No. 102004062439.9, filed Dec. 17, 2004, and claims the benefit of U.S. Provisional Application No. 60/638 538, filed Dec. 22, 2004, which is herewith incorporated into this application by explicit reference.

### FIELD OF THE INVENTION

The invention relates to a device for spraying liquid mixtures, in particular for discharging crop protection agents in agriculture, having at least one spray nozzle and a mixing device attached in front thereof having a metering device for the liquids to be mixed and a cylindrical mixing chamber with tangential liquid supply.

### BACKGROUND OF THE INVENTION

A device of this type is known from EP 0 347 421 81.Here water is supplied tangentially to one end of a cylindrical mixing chamber for mixing with the pesticides supplied axially at the center of the same end during passage through the mixing chamber. To promote this mixing process, the mixing chamber there is also provided with inward-protruding fins diametrically opposite. Devices of this type require considerable space, which however is not available for spraying equipment in agriculture especially when the agents are to be admixed as closely as possible in front of the spray nozzles.

Devices of the type described at the outset have however the advantage that the agents can, depending on the travel speed, be added discontinuously by means of pumping pulses and that the otherwise usual mixing of the crop protection agents with water in a fluid tank is not necessary, while the concentrations thus created can no longer be altered and remaining quantities require expensive disposal.

### SUMMARY OF THE INVENTION

The object underlying the present invention is therefore to evenly spread and mix the discontinuously conveyed agent volumes in the longitudinal direction of the volume flow of the carrier liquid, regardless of the available volume flow of the carrier liquid. It is well known that agricultural crop sprayers are designed for discharging a liquid quantity, i.e. a carrier liquid including the agents, of at least 800 Iiters per hectare, with the pipe cross-sections being dimensioned accordingly. In the majority of applications, however, only between 150 and 200 Iiters per hectare, and in exceptional cases even less, are discharged, so that the mixing device should—if it is to operate without active mechanical elements that take up space and are complicated—meet the requirements placed on it even with a small proportion of the maximum volume flow and only with the flow energy of the liquid flowing through it.

The invention entails, in a device of the type mentioned at the outset, that the metering device is arranged in front of or upstream of the mixing chamber and that the liquid supply is provided with one or more outlet apertures of which the free cross-section is determined by a control element opening or closing depending on the liquid pressure. With the invention, therefore, the carrier liquid, as a rule water, is passed together with the agents admixed to it into the mixing chamber in such a way that the liquid is passed first along the outer wall of the mixing chamber and then into its interior, the result being that rotation of the liquid is generated and hence excellent mixing is achieved which is consistent over the entire length of the mixing chamber. The outlet apertures advantageously extend for example over at least 75% of the entire axial length and in particular over the entire axial length of the mixing chamber.

In an advantageous embodiment, the liquid supply into the mixing chamber can be designed as a slot running substantially over the entire length of the mixing chamber and having a width determined by the control element. This embodiment ensures an even supply of the liquid over the entire length of the mixing chamber, where the control element can be a spring-loaded control flap of which the free end is located in front of the slot. This embodiment in turn ensures that the intake cross-section is restricted over the entire length of the mixing chamber so that a sufficient acceleration of the liquid in the tangential direction is generated even with a fraction of the maximum possible volume flow.

In an advantageous embodiment of the invention, the mixing chamber can be provided here with an outflow aperture for exhausting the liquid mixture from the mixing chamber that is located in the middle of the mixing chamber. It can be advantageously designed as a gap in an outflow pipe running axially and centrally in the mixing chamber, with an advantageous effect being achieved in that the gap is arranged opposite the rotation direction of the liquid, runs parallel to the liquid supply and discharges tangentially into the outflow pipe. This gap too in the outflow pipe can run substantially over the entire length of the mixing chamber. The spring-loaded control flap at the inlet to the mixing chamber ensures that as the pressure of the liquid flow on the control element increases, i.e. with greater volumes of the liquid to be discharged, the spring element yields, so that the inlet cross-section increases. The cross-section of the tangential inlet aperture thus adjusts automatically to the volume flow thanks to appropriately dimensioned or adjusted spring yielding. This volume flow is here not in principle restricted to the possible maximum, but only to the extent that the tangential flow required is always generated.

With the embodiment according to the invention, the accelerated and tangentially entering volume flow first moves along the inner wall of the mixing chamber and, when it returns to the area of the inlet aperture, forces itself underneath the newly inflowing layer of liquid. The results of the different rotation speeds of these liquid layers are the deliberate deflection of the volume flow passing through the chamber and intensive swirling. Additional inserts in the form of swirling elements or fins in the mixing chamber are not necessary.

In a further possible embodiment of the invention, the control element can be provided instead of a spring-loaded control flap but also designed as a curved leaf spring located in the mixing chamber, the free end of which spring extends over the outlet apertures. This leaf spring is here adapted to the curvature of the inner wall of the mixing chamber and rests against this inner wall. It can be provided with recesses for determining its resistance, these recesses ideally running in the direction of the curvature. With this embodiment, it is particularly advantageous if the mixing chamber is provided with an outflow pipe that runs radially in the mixing chamber halfway along its length. The inlet aperture of the outflow pipe should ideally be in a plane passing though the central axis of the mixing chamber. The leaf spring itself can be advantageously provided with a fastening hole enclosing the outflow pipe so that the leaf spring can be held clamped in simple manner inside the mixing chamber. In this case too, the mixing operation is performed as previously mentioned. The advantage of this embodiment is above all that the size of the parts to be used is greatly reduced. The discharged volume flow does not hinder here, due to the arrangement of the outflow pipe and its inlet aperture in the center of the mixing chamber, the rotation of the mixing chamber's contents.

In an embodiment of the invention, the outlet apertures for supplying liquid are at least partly arranged in the area of an end face of the cylindrical mixing chamber and at least one of the outlet apertures is aligned with one main component vertical and tangential to a central longitudinal axis of the mixing chamber and with a further main component parallel to the central longitudinal axis.

In this way, a tangential flow in the mixing chamber can be generated by means of the outlet aperture which is aligned in a plane parallel to the central longitudinal axis obliquely upwards into the mixing chamber. This tangential flow is furthermore in helical form to that end of the mixing chamber opposite the end face with the outlet aperture. In this way, it is possible even with small liquid quantities to obtain a strong rotation and turbulence of the liquid inside the mixing chamber that is advantageous for good mixing. A further outlet aperture can be arranged in the area of an intersection of the central longitudinal axis with the end face of the mixing chamber. In this way, the elements for generating a rotation of the flow in the mixing chamber and the elements for supplying liquid in variable quantities can be separated. To do so, the outlet aperture for generating the rotating flow in the mixing chamber is advantageously dimensioned so small that rotation and turbulence of the flow sufficient for good mixing are generated even with the smallest liquid throughput provided for. Further outlet apertures can then be used for introducing larger liquid quantities into the mixing chamber and mixing them if required. The separation of the rotation-generating outlet apertures and of the outlet apertures intended for supplying a variable liquid quantity allows excellent mixing of the supplied liquids over a very wide range of liquid quantities supplied. The outlet apertures intended for supplying a variable liquid quantity can also be arranged displaced to the central longitudinal axis of the mixing chamber and thereby also contribute to generating rotation and turbulence in the mixing chamber.

In an embodiment of the invention, the outlet aperture aligned tangentially to the central longitudinal axis has a constant cross-section not determined by the liquid pressure, and at least one further outlet aperture is provided of which the free cross-section is determined by a control element opening or closing depending on the liquid pressure.

In this way it is assured that sufficiently large rotation and turbulence of the flow are always generated inside the mixing chamber by means of the tangentially aligned outlet aperture, regardless of the supplied liquid quantity, from the smallest liquid throughput to be mixed to the largest intended liquid throughput through the mixing chamber. A pressure drop over the mixing chamber is here constant regardless of the throughput liquid quantity, since the control element opens or closes depending on the liquid pressure. With high liquid quantities for throughput, the control element thus opens further, so that the pressure drop over the mixing chamber always has a constant value. The control element is spring loaded or pretensioned against the inflowing liquid in another way. By adjusting the opening pressure and the opening rate of the control element and the size of the outlet aperture which can not be closed by the control element, a pressure drop over the mixing chamber can be adjusted to always be constant, e.g. 0.5 bars, regardless of the liquid quantity for throughput.

In an embodiment of the invention, an outflow aperture for exhausting liquid form the mixing chamber is arranged in the area of the end face of the mixing chamber with the outlet apertures for supplying liquid.

In this way, the liquid, which starting from the end face is imparted with a helical rotation away from that end face, must pass substantially through the entire mixing chamber and then return to the outflow aperture in the end face. This achieves a particularly thorough mixing of two or more supplied liquids.

In an embodiment of the invention, one end of the mixing chamber opposite the end face with the outlet apertures is designed dome-like, in particular in spherical segment form. This allows flow conditions favorable for good mixing to prevail inside the mixing chamber.

The object underlying the present invention is also solved by a cylindrical mixing chamber for mixing at least two liquids where one or more outlet apertures are provided, at least one of which is aligned tangentially to a central longitudinal axis of the mixing chamber and a free cross-section of the outlet apertures is determined at least partially by a control element opening or closing depending on the liquid pressure.

With a mixing chamber of this type, it is possible for two or more liquids to be very thoroughly mixed over a very large range of liquid quantities for throughput through the mixing chamber. This is because the elements for generating a rotating flow and for generating turbulence in the mixing chamber, i.e. the tangentially arranged outlet apertures, and the elements for supplying a variable liquid quantity, i.e. the outlet apertures opening and closing by means of a control element, are separate from one another, so that it is always assured that rotation or turbulence sufficient for thorough mixing forms in the mixing chamber, regardless of the liquid quantity supplied. The mixing chamber in accordance with the invention can also be used in modular form, so that two mixing chambers connected parallel are used for mixing large liquid quantities.

### BRIEF DESCRIPTION OF THE DRAWINGS

The invention is illustrated on the basis of design examples in the drawing and explained in the following. Further features and advantages of the drawing are shown in the description and the claims. Individual features of the embodiments described in the drawings, the description and the claims can be combined in any way without leaving the scope of the invention. The drawings show, in

FIG. 1 a diagrammatic view of a cross-section through a mixing chamber of a spraying device in accordance with the invention for discharging crop protection agents in agriculture, having a pivotable flap as the control element for the mixing chamber inflow during operation for a low discharge volume,

FIG. 2 a longitudinal section through the mixing chamber of FIG. 1, along the section II-II in FIG. 1, however without the control flap being shown,

FIG. 3 the cross-section of the mixing chamber according to FIG. 1, however in operation for a high discharge volume,

FIG. 4 a variant of a mixing chamber of a spraying device where a yielding leaf spring is inserted into the mixing chamber instead of a pivotable flap,

FIG. 5 the enlarged perspective view of the leaf spring of the mixing chamber in FIG. 4,

FIG. 6 a plan view onto a further variant of a mixing chamber of a spraying device,

FIG. 7 a sectional view along the line VII-VII in FIG. 6,

FIG. 8 a sectional view along the line VIII-VIII in FIG. 7,

FIG. 9 a variant of a mixing chamber in a lateral sectional view and

FIG. 10 a plan view onto the mixing chamber of FIG. 9.

### DETAILED DESCRIPTION

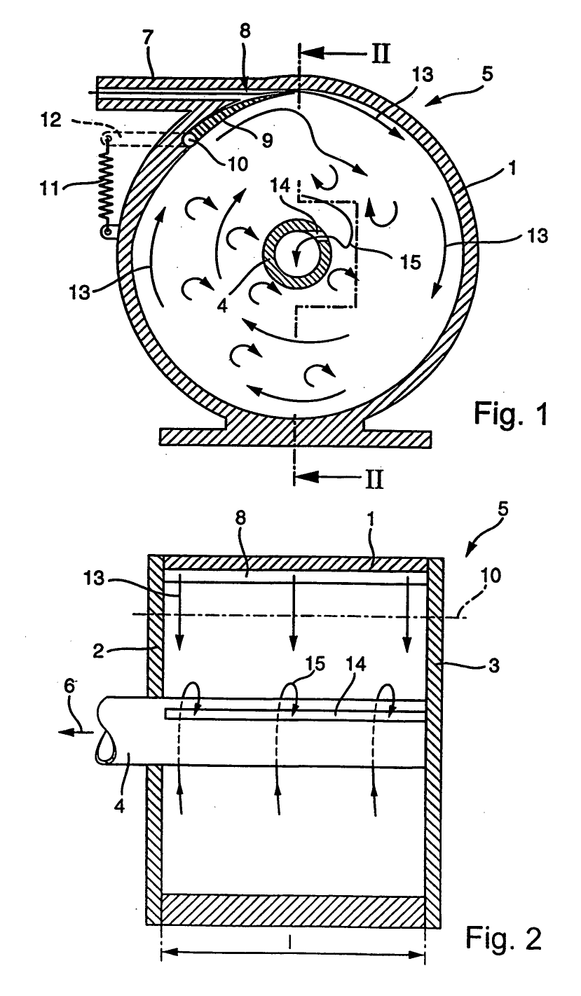

FIGS. 1 to 3 show a mixing chamber of an agricultural spraying device using which crop protection agents mixed with a certain amount of water as the carrier liquid are to be sprayed in agriculture. This is achieved with the aid of spray nozzles fitted to carrier arms and mostly spread several meters transverse to the driving direction of a tractor. The mixture of crop protection agents and water is supplied by pumps to the spray nozzles, with one or if necessary more metering devices admixing the required amount of crop protection agent to the water before this is supplied in accordance with the invention to the mixing chamber according to FIGS. 1 to 3.

Since the quantity of spray agent to be discharged depends on the travel speed of the tractor if each hectare of soil is to receive a defined amount of the crop protection agent, the necessary volume flow of carrier liquid mixed with crop protection agent changes depending on application. The mixing chamber 5 is designed to achieve flawless mixing of the water and the crop protection agent supplied to it before the mixing chamber, regardless of the quantity of liquid supplied to the chamber.

It consists in the design example shown of a cylindrical housing 1 closed at both ends by covers 2 and 3, where at least one of the covers, in this case cover 2, is passed through by an outflow pipe 4 through which the liquid introduced into the mixing chamber 5 for the purpose of intensive mixing can exit in the direction shown by the arrow 6 and be passed to the spray nozzles, not shown.

The cylindrical housing of the mixing chamber 5 has a liquid supply in the form of an inlet connection 7 whose inner supply duct opens tangentially into the interior of the housing 1 with a slot 8 which in the design example extends over the entire length 1 of the housing 1.

In front of the slot 8 representing the opening of the liquid supply into the housing 1 is arranged a flap 9 pivoting about the axis 10 and, as shown in the diagram, held with its free end in front of the slot 8 by a tension spring 11 attached to the outside of the housing and engaging a lever 12 firmly connected to the swivel axis 10. The spring 11 is designed such that the pressure of the liquid passing through the connection 7 swivels the flap 9 more or less in the clockwise direction so that the free inlet cross-section of the slot 8 to the interior of the mixing chamber 5 adjusts automatically to the supplied liquid quantity, which in this way is always guided along the inner wall of the housing 1 into the mixing chamber and after one rotation in the direction of the arrows 13 passes on the inside over the layer of the newly inflowing liquid. An intensive swirling is achieved by the varying speeds of the rotating liquid layers. This is further promoted by the fact that the outflow pipe 4 running centrally inside the cylindrical housing 1 is provided with an inlet slot 14 aligned opposite to the rotation direction and in turn discharging tangentially into the outflow pipe 4. The liquid quantity entering the outflow pipe 4 in the direction of the arrow 15 is therefore subjected to an opposite-direction rotation inside this pipe. This embodiment of the mixing chamber ensures an even and homogeneous mixing of the crop protection agent in the water, thus also ensuring that the quantity of crop protection agent discharged onto the soil is always constant.

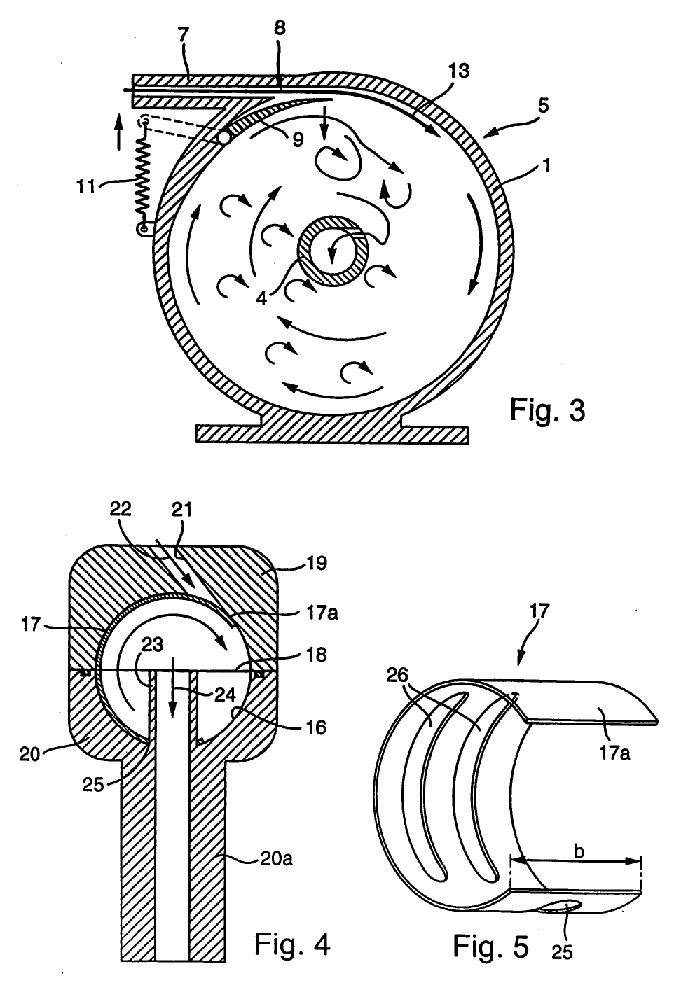

FIG. 3 shows by way of explanation the mode of operation of the mixing chamber 5 for larger discharge quantities. As a result, the higher pressure of the supplied larger quantity of carrier liquid and crop protection agent opens the pivoting flap 9 more than in the case in FIG. 1, so that the free cross-section of the inlet slot 8 is increased and in this case too the liquid is introduced into the housing 1 in tangential contact in the direction of the arrows 13. The free cross-section of the inlet slot 8 is therefore, depending on the supplied quantity, always regulated such that the inlet speed of the liquid is sufficient to pass the liquid along the inner wall of the mixing chamber 5 and in this way to provide the flow path required for mixing inside the mixing chamber.

The metering of the crop protection agent into the carrier liquid can be achieved here in the known manner by pulsed operation, in order to distribute even very small quantities of crop protection agent inside the carrier fluid. A subsequent even mixing is of particular importance in those cases where the crop protection agent is introduced discontinuously into the carrier liquid flow.

FIG. 4 now shows a modified embodiment of a mixing chamber in accordance with the invention where instead of the pivoting flap 9 a curved leaf spring 17 adapted to the diameter and the circumference of the cylindrical mixing chamber 16 is provided, and shown in enlarged detail in FIG. 5. This mixing chamber 16 is formed by a two-part housing split in a plane 18 running through the central axis of the cylindrical chamber 16 and comprising an upper part 19 and a lower part 20 that is also provided with the outflow pipe 20a. The upper part 19 is provided with the supply duct 21 that opens, as in the design example in FIGS. 1 to 3, tangentially into the mixing chamber 16 so that the liquids to be mixed, i.e. crop protection agents and water, can be introduced in the direction of the arrow 22 into the mixing chamber 16. The lower part 20 has an outflow pipe connection 23 which projects radially into the center of the mixing chamber 16, seen in the longitudinal direction of the latter, and has its inlet aperture in the plane 18, so that the liquids mixed in the mixing chamber 16 can be passed to the outside in the direction of the arrow 24 through the outflow duct inside the tube 20a.

The leaf spring 17 is positioned with its free end 17a in front of the opening of the supply duct 21. It is provided with a hole 25 and can be inserted into the mixing chamber 16 via the inlet connection 23 of the housing lower part 20 and fixed before the upper part 19 is attached. The leaf spring 17 is designed such that it is in contact with the inner wall of the mixing chamber 16, and it can be provided with recesses 26 which generate the necessary spring characteristic for the leaf spring 17 and for its free end 17a. In this case too, the free end 17a of the leaf spring 17 yields to the pressure of the liquid supplied in the direction of the arrow 22, and as the liquid pressure increases the free cross-section of the opening of the inlet duct 21 also increases. The effect of the mixing chamber 16 according to FIG. 4 is hence the same as that of the mixing chamber 5 in FIGS. 1 to 3. The embodiment shown in FIG. 4, in which the width b of the leaf spring 17 matches the length of the cylindrical mixing chamber 16, does however have the advantage of a very small space requirement, so that this type of mixing chamber is also suitable directly in front of individual spray nozzles or spray nozzle sections and in particular for integrated arrangement on a nozzle holder if the agents are not to be admixed until there.

In the embodiment shown in FIG. 4, the volume flow passing through the mixing chamber leaves the latter in the middle of its diameter and the inlet aperture of the outflow connection 23 should advantageously, as already stated above, be precisely in the center of the mixing chamber 16 at a neutral position so that the outgoing volume flows do not hinder the rotation of the mixing chamber contents. In this case too, the constriction of the supply cross-section generates-even with low volume flows a sufficient flow speed in the tangential direction, so that a sufficient tangential flow speed is also achieved at volume flows well below the maximum taken into account in the design of the mixing chamber. The recesses 26 in the leaf spring 17 or other recesses or measures ensure the required elasticity of the leaf spring in the area of its free end 17a. They can be correspondingly designed and provided depending on the application.

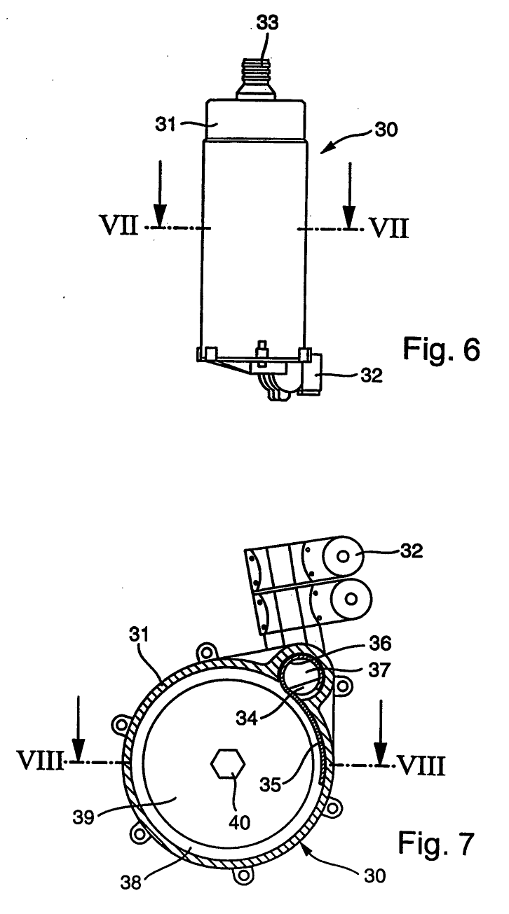

A further variant of a cylindrical mixing chamber 30 for the spraying device in accordance with the invention is shown in a plan view in FIG. 6. The mixing chamber 30 has a hollow-cylindrical housing 31 into which carrier liquid and agent are introduced via a connection 32 not indicated in detail. Carrier liquid and agent leave the housing 31 in the mixed state via an outlet connection 33 arranged concentrically to the housing 31 at an axial end of the mixing chamber 30 and provided with a male thread.

The sectional view in FIG. 7 shows a section through the mixing chamber 30 along the line VII-VII of FIG. 6. It will be seen that the agent and the carrier liquid are introduced by the connection 32 into a duct 34 running parallel to the longitudinal axis of the housing 31 and covered from the inside of the mixing chamber 30 by means of a leaf spring 35. The leaf spring 35 is used as the control element and is pretensioned to the position shown in FIG. 7. As already discussed on the basis of the previously described variants, the carrier liquid and the agent in the duct 34 are forced to pass between the leaf spring 35 and the inner wall of the housing 31. The liquid thus passes into the interior of the housing 31 exclusively parallel to its inner wall, so that a rotation of the liquid results inside the mixing chamber 30. The size of an inlet gap between the leaf spring 35 and the inner wall of the housing 31 is regulated here by the liquid pressure in the duct 34 and by the pretensioning force of the leaf spring 35. The leaf spring 35 is attached to the housing 31 by its end facing away from the inlet gap being curled by nearly 360° in order to form an eye 36. This eye 36 is fitted over the pin 37 in the housing 31 such that the leaf spring 35 can be attached in a particularly simple manner to the housing 31. The pin 37 is flattened on one side to form a section of the duct 34. A corresponding pin can be provided at the opposite end of the mixing chamber housing 31 or in a cover in order to securely fasten the leaf spring 35 at both axial ends.

Unlike the previously described variants, the mixing chamber 30 has an outflow aperture in the form of an annular gap 38 provided in one end face of the mixing chamber 30. The annular gap 38 is here adjacent on the one side to the inner wall of the cylindrical housing 31 and on the other side to the outer circumference of an end face cover 39 inserted into the mixing chamber housing 31. The end face cover 39 has in the center an internal hexagon 40 to facilitate its fitting.

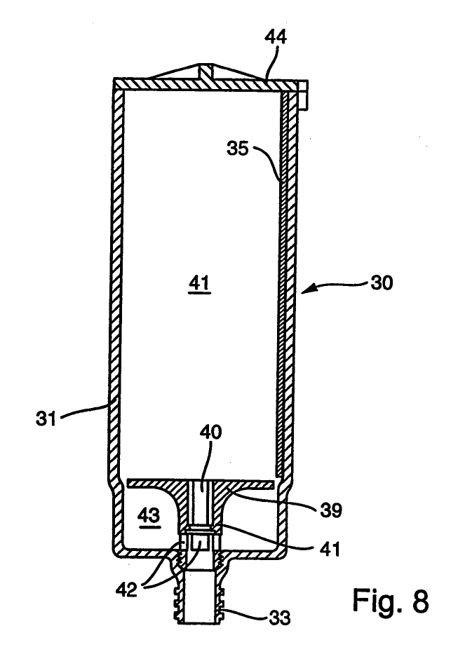

The design of the end face cover 39 can be seen more clearly in the sectional view in FIG. 8 along the line VIII-VIII of FIG. 7. The end face cover 39 has a flat surface facing the actual mixing chamber interior 41 and thus closes this mixing chamber interior 41 at one face, however with an all-round annular gap between an inner wall of the housing 31 and an outer circumference of the end face cover 39. The liquid in rotation inside the mixing chamber interior 41 can hence be removed from said interior 41 without noticeably disturbing the rotation therein. It can thus be ensured that even with low flow speeds the rotation inside the mixing chamber interior 41 can be sustained and hence a dependable mixing guaranteed. The end face cover 39 has opposite its flat surface a cylindrical projection 41 that has a male thread and is screwed into a matching female-threaded hole in the mixing chamber housing 31. This female thread hole and hence the cylindrical projection 41 too are aligned with the outlet connection 33 of the mixing chamber housing 31. To permit the liquid to exit from the mixing chamber and into the interior of the cylindrical projection 41, the latter is of tubular design and can be provided with several passage apertures 42 spread around its circumference. Between an inner wall of the housing 31 and that side of the end face cover 39 facing away from the mixing chamber interior 41, a further toroid mixing chamber interior is formed in which further mixing of the agent and the carrier liquid can take place before the agent/carrier liquid mixture then exits through the passage apertures 42 and out of the outlet connection 33.

Clearly-visible in FIG. 8 is the particularly simple design of the mixing chamber 30. The housing 31 is designed cup-like and has in the center of its bottom end the outlet connection 33. The end face cover 39 is inserted into this cup-like housing 31 and screwed into the bottom of it. The internal hexagon 40 in the end face cover 39 is used to do so. The leaf spring 35 can also be inserted simply into the interior of the housing 31 and, as already explained, be mounted on a suitable pin there. The housing 31 is then closed using a cover 44.

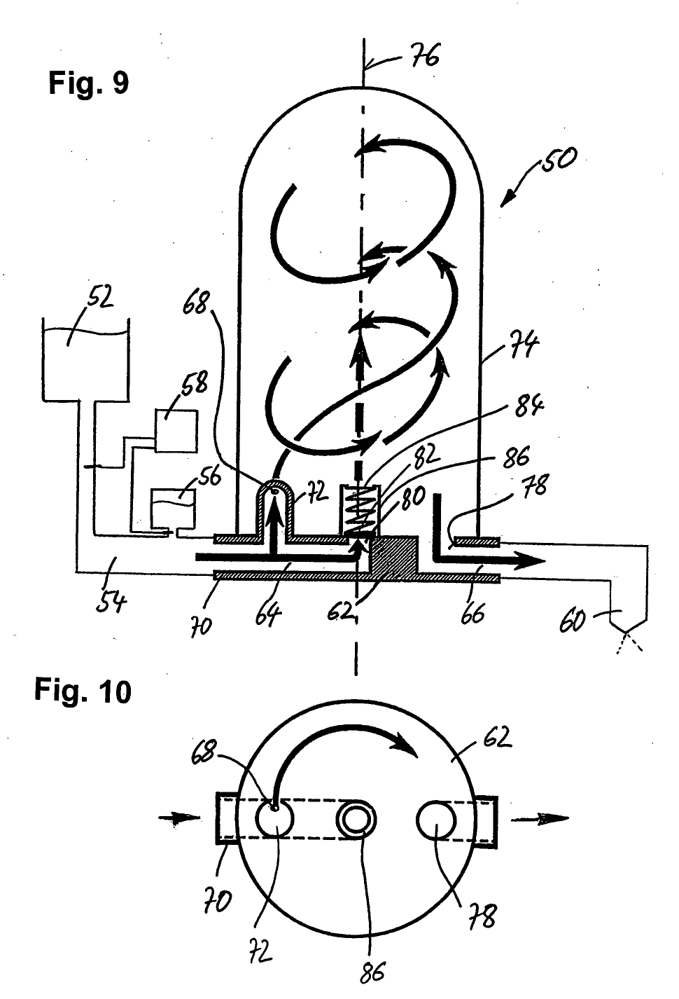

FIG. 9 shows a further embodiment of a mixing chamber 50 in accordance with the invention. The mixing chamber 50 is part of a device for spraying liquid mixtures, in particular for discharging crop protection agents in agriculture, for example part of a so-called crop sprayer. FIG. 9 shows only in diagrammatic form a water tank 52 connected by means of a supply line 54 to the mixing chamber 50. Crop protection agent from an agent tank 56 is metered in variable quantities into the supply line 54. The ratio of water from the water tank 52 and agent from the agent tank 56 is set by means of a control unit 58 that operates control values, only indicated in diagrammatic form, inside the supply line 54 and in the line between the agent tank 56 and the supply line 54. It is of course possible to provide several agent tanks 56 with different agents.

Downstream of the mixing chamber 50 at least one spray nozzle 60 is provided with which the mixture mixed in the mixing chamber 50 can be discharged.

The mixing chamber 50 itself has a substantially cylindrical baseplate 62 provided with a supply duct 64 continuing the supply line 54 and an outflow duct 66. The outflow duct 66 opens into a feed line to the spray nozzle 60. The supply duct 64 leads, initially starting from a connection 70, into the baseplate 62 and then branches off in the direction of an outlet aperture 68 of nozzle-like design. A connection between the supply duct 64 and the interior of the mixing chamber 50 is made with the outlet aperture 68. The outlet aperture 68 is provided at a dome-like end of an otherwise cylindrical projection 72 that extends from the baseplate 62 into the interior of the mixing chamber 50. The interior of the mixing chamber 50 is limited on the one side by the baseplate 62 and on the other side by a substantially cylindrical housing 74 which is in sealing contact with an all-round edge on the baseplate 62 and is closed at the other end by a dome in the form of a spherical segment. The outlet aperture 68 is here aligned obliquely upwards into the interior of the mixing chamber 50. The outlet aperture 68 is thus aligned on the one side with one main component vertical and tangential to a central longitudinal axis 76 and on the other side with another main component parallel to the central longitudinal axis 76. For example, the outlet aperture 68 is aligned relative to the baseplate 62 obliquely upwards at an angle between 35° and 50° and at the same time tangentially to an imaginary circular cylinder about the central longitudinal axis 76.

As can be seen in FIG. 9, liquid exiting from the outlet aperture 68 is thus conveyed upwards helically, so that the liquid inside the mixing chamber 50 is set in rotation. This rotation movement is aligned on the one hand about the central longitudinal axis 76 and on the other hand away from the baseplate 62.

An outflow aperture 80 from the interior of the mixing chamber 50 is also arranged in the baseplate 62. As a result, before the liquid exits through the outflow aperture 78 the direction must be reversed in the mixing chamber 50 and specifically in the housing 74. Together with the rotation generated by the outlet aperture 68 the result is a thorough mixing of the introduced liquids, i.e. water from the water tank 52 and agent from the agent tank 56.

The outlet aperture 68 has a constant and invariable cross-section and is dimensioned such that powerful rotation and turbulence are generated inside the mixing chamber 50 even with the smallest liquid throughput provided for, so that thorough mixing of agent and water is assured.

If the liquid throughput through the mixing chamber 50 is to be increased, first the liquid pressure in the supply line 54 is increased. As a result, liquid can now pass not only through the outlet aperture 68 into the mixing chamber, but also through a further outlet aperture 80 which is arranged at the end of the supply duct 64 and downstream of the outlet aperture 68 and closed in the no-pressure state and below its opening pressure by means of a spring-loaded closing plate 82. The closing plate 82 is pretensioned by a helical spring 84 against the edging of the outlet aperture 80. The helical spring 84 is here arranged in a cylindrical sleeve extending from the baseplate 62 and surrounding the outlet aperture 80 and having at its end facing away from the baseplate 62 a ledge reducing the free cross-section. The helical spring 84 rests on this ledge and can therefore exert a spring force on the closing plate 82. Depending on the liquid pressure prevailing in the supply duct 64, the closing plate 82 is lifted different distances off the baseplate 62, so that the free cross-section of the outlet aperture 80 is determined depending on the liquid pressure. The pretensioning force of the spring 84 can for example be dimensioned here such that regardless of the liquid quantity to pass through the mixing chamber 50 the maximum pressure loss occurring is always 0.5 bar.

It can be seen that the outlet aperture 68 for generating the rotating and turbulent flow is provided in the mixing chamber 50. Separately from this, the outlet aperture 80 sealed by the spring-loaded closing plate 82 is provided for introducing the liquid if a further outlet aperture with variable cross-section is to be provided additionally to the outlet aperture 68.

The outlet aperture 68 for supplying liquid on the projection 72 is here arranged radially on the outside relative to the cylindrical baseplate 62, and at the same radial distance from the central longitudinal axis 76 as the outflow aperture 78 for exhausting liquid, however on the opposite side. The outlet aperture 80 for supplying liquid is by contrast arranged in the area of the central longitudinal axis 76 and specifically concentric to the central longitudinal axis 76.

This can be clearly seen in the plan view of FIG. 10, where the outlet aperture 68 can also be seen using which the liquid is fed tangentially into the mixing chamber 50 in order to generate a rotating and turbulent flow in the mixing chamber.

The mixing chamber 50 can also be used in modular form for coping with higher liquid throughputs by connecting two mixing chambers 50 in parallel. This can be achieved for example by providing the underside of the baseplate in FIG. 10 with a further mixing chamber housing and also on the underside, similar to FIG. 10, two outlet apertures and one outflow aperture which are then connected to the supply duct 64 and outflow duct 66.

1. Device for spraying liquid mixtures, in particular for discharging crop protection agents in agriculture, comprising:
at least one spray nozzle,
a mixing device,
said mixing device being arranged upstream of the spray nozzle,
said mixing device having a metering device for the liquids to be mixed,
a cylindrical mixing chamber, and liquid supply means for supplying liquid to the mixing chamber,
said metering device being arranged upstream of the mixing chamber,
said liquid supply means having at least one outlet aperture for supplying liquid to the mixing chamber the free cross section of at least one outlet aperture for supplying liquid being determined by a control element opening of closing depending on the liquid pressure.

2. Device according to claim 1, wherein the outlet apertures extend over the entire axial length of the mixing chamber.

3. Device according to claim 2, wherein the liquid supply is designed as a slot running substantially over the entire length of the mixing chamber and having a width determined by the control element.

4. Device according to claim 1, wherein the control element is a spring-loaded control flap.

5. Device according to claim 4, wherein a free end of the spring-loaded control flap is in front of the at least one outlet aperture.

6. Device according to claim 1, wherein the mixing chamber is provided with an outflow aperture for exhausting the liquid mixture from the mixing chamber that is located in the middle of the mixing chamber.

7. Device according to claim 6, wherein the outflow aperture for exhausting liquid is designed as a gap in an outlet pipe running axially and centrally in the mixing chamber.

8. Device according to claim 7, wherein the gap is arranged opposite the rotation direction of the liquid in the mixing chamber.

9. Device according to claim 7, wherein the gap runs parallel to the liquid supply and discharges tangentially into the outlet pipe.

10. Device according to claim 7, wherein the gap runs substantially over the entire length of the mixing chamber.

11. Device according to claim 1, wherein the control element is a leaf spring located in the mixing chamber, the free end of which spring extends over the outlet apertures for supplying liquid.

12. Device according to claim 11, wherein the leaf spring is adapted to the curvature of the inner wall of the mixing chamber and rests against this inner wall.

13. Device according to claim 11, wherein the leaf spring is provided with recesses for determining its resistance.

14. Device according to claim 13, wherein the recesses run in the direction of the curvature.

15. Device according to claim 9, wherein the mixing chamber is provided with an outlet pipe that runs radially in said mixing chamber halfway along its length.

16. Device according to claim 15, wherein the inlet aperture of the outlet pipe is in a plane passing through the central axis of the mixing chamber.

17. Device according to claim 15, wherein the leaf spring is provided with a fastening hole enclosing the outlet pipe.

18. Device according to claim 1, wherein the mixing chamber is provided with an outflow aperture for exhausting the liquid mixture from the mixing chamber being arranged in an axial end face of the mixing chamber and being designed as a gap running at least in sections around a central longitudinal axis of the mixing chamber.

19. Device according to claim 18, wherein the gap extends in the radial direction up to the cylindrical inner wall of the mixing chamber.

20. Device according to claim 1, wherein the outlet apertures for supplying liquid are at least partly arranged in an end face of the cylindrical mixing chamber and wherein at least one of the outlet apertures for supplying liquid is arranged with a first main component tangentially to a central longitudinal axis of the mixing chamber.

21. Device according to claim 20, wherein the at least one outlet aperture for supplying liquid and being arranged with a first main component tangentially to the central longitudinal axis is arranged with a second main component parallel to the central longitudinal axis.

22. Device according to claim 20, wherein the at least one outlet aperture for supplying liquid and being arranged tangentially to the central longitudinal axis has a constant free cross section not being influenced by the liquid pressure and wherein
at least one further outlet aperture for supplying liquid is provided, the free cross section of which being determined by a control element opening or closing depending on the liquid pressure.

23. Device according to claim 20, wherein an outflow opening for exhausting liquid from the mixing chamber is arranged in the end face of the mixing chamber having the at least one outlet aperture for supplying liquid to the mixing chamber.

24. Cylindrical mixing chamber for mixing at least two liquids, comprising:
at least one outlet aperture for supplying liquid into the mixing chamber, said at least one outlet aperture being arranged tangentially to a central longitudinal axis of the mixing chamber,
a free cross section of said at least one outlet aperture being determined by a control element opening or closing depending on the liquid pressure.

25. Cylindrical mixing chamber for mixing at least two liquids, comprising:
at least two outlet apertures for supplying liquid into the mixing chamber,
at least one of said at least two outlet apertures being arranged tangentially to a central longitudinal axis and having a constant free cross section,
at least another one of said at least two outlet apertures having a free cross section which is determined by a control element opening or closing depending on the liquid pressure.
